(19) United States
(12) Patent Application Publication
(10) Pub. No.: US 2006/0152526 A1
(43) Pub. Date: Jul. 13, 2006

(54) Method for adaptively improving image quality according to display device in mobile terminal

(75) Inventors: Yu Nam Kim, Seoul (KR); Seong Chan Byun, Seoul (KR); Eun Sil Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/327,539

(22) Filed: Jan. 5, 2006

(30) Foreign Application Priority Data
Jan. 7, 2005 (KR) 10-2005-0001842

(51) Int. Cl. G09G 5/02

(52) U.S. Cl. 345/589

(57) ABSTRACT

There is provided a method for adaptively improving an image quality according to the characteristic of a display device in a mobile terminal. In the method, a color matching table is set for an adaptive image compensation according to the characteristic of the display device in the mobile terminal. A color value of a decoded image signal is converted with reference to the color matching table, for displaying the converted image signal on the display device. The image signal, which is adaptively converted according to the characteristic of the display device, is displayed.

Pursuant to 35 U.S.C. §119(a), this application claims the benefit of earlier filing date and right of priority to Korean Patent Application No(s). 10-2005-0001842 filed on Jan. 7, 2005, which is hereby incorporated by reference herein in their entirety.

### BACKGROUND OF THE INVENTION

1. Field of the Invention

The present invention relates to a method for improving an image quality, and more particularly, a method for adaptively improving an image quality by compensating for an image to be displayed, according to the characteristic of a display device in a mobile terminal.

2. Description of the Related Art

As a transmission mode of a mobile terminal has been developed, a technology is commercialized, which is capable of reproducing a TV broadcasting or a digital multimedia broadcasting (DMB) at the mobile terminal. In addition, there has been gradually developed a function of the mobile terminal that a user photographs a moving picture using a built-in camera of the mobile terminal and reproduces it, or a function that enables a moving picture for a video communication or a moving picture produced by the user oneself to be also reproduced at another mobile terminal.

In case of reproducing the moving picture data received at the mobile terminal or the moving picture data encoded at the mobile terminal itself, there has been employed a method that a moving picture data stream or the encoded moving picture is decoded using a decoder in the mobile terminal and the decoded moving picture is displayed on the display device.

A constitution of a mobile terminal with a related art digital image display device built in and an operation thereof will be illustrated with reference to attached drawings.

FIG. 1 is a block diagram of a mobile terminal with a related art camera built in. Referring to FIG. 1, the mobile terminal with the related art camera built in includes an external image detection unit 110, an image signal detection unit 120, a signal selection unit 125, an image decoder 130, a display device 140, a control unit 150, and a user command input unit 160. Herein, the external image detection unit 110 is provided with an image acquisition unit 111, and an image encoder 112. The image signal detection unit 120 is provided with a receiving unit 121 and a demultiplexer 122.

A user inputs an object-photographing command or a reproducing command for a received image through the user command input unit 160. The control unit 150 performs a switching operation such that the signal selection unit 125 selects the output of the external image detection unit 110, when taking a picture of the object. The image acquisition unit 111 of the external image detection unit 110 converts an image of the object into an electrical signal, and the image encoder 112 encodes the output signal of the image acquisition unit 111. When reproducing the received image, the control unit 150 performs a switching operation such that the signal selection unit 125 selects the output of the image signal detection unit 120. The receiving unit 121 of the image signal detection unit 120 receives a transmission stream such as a video on demand (VOD) stream, a video communication data, a digital TV signal, or the like. The output of the receiving unit 121 is demultiplexed through the demupltiplexer 122 and is outputted as an image data.

The image signal acquired and encoded at the image detection unit 110 or the image signal outputted from the image signal detection unit 120 is inputted into the image decoder 130 through the signal selector 125. The image decoder 130 decodes the inputted encoded image signal so as to output a decoded image signal into the display device 140. The display device 140 displays the image of the object photographed through the image acquisition unit 111 or the image received through the image signal detection unit 120 on a screen.

In this manner, in displaying the taken image of the object on the display device in the mobile terminal with the built-in camera, there is little difference in the function of the decoder but there may be large difference in the function of the display device. Therefore, it is required a method of displaying an adaptive image according to the characteristic of the display device, considering the characteristics of different display devices. In addition, since the characteristics of the image display devices are different from one another in respective mobile terminals, it may be difficult to reproduce an original image with high fidelity, in case of displaying the image transferred from one mobile terminal to another mobile terminal, or an image signal acquired from another image resource, on the display device in user's mobile terminal. For example, it may occur that a deteriorated image, of which color becomes different from the color of the original image, is displayed on the display device of the mobile terminal.

### SUMMARY OF THE INVENTION

Accordingly, the present invention is directed to a method for adaptively improving an image quality according to a display device in a mobile terminal that substantially obviates one or more problems due to limitations and disadvantages of the related art.

An object of the present invention is to provide a method for improving an image quality of an image displayed in a mobile terminal.

Another object of the present invention is to provide a method for improving an image quality based on an adaptive image compensation according to the characteristic of the mobile terminal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for adaptively improving an image quality according to a display device in a mobile terminal, the method including: receiving a decoded image frame data for displaying it in the mobile terminal; converting a color value of the inputted image frame data, considering the characteristic of the display device; and displaying the converted image signal.

In another aspect of the present invention, there is provided a method for adaptively improving an image quality according to a display device in a mobile terminal, the method including: setting a color matching table for an adaptive image compensation according to the characteristic of the display device in the mobile terminal; converting a color value of a decoded image signal with reference to the color matching table, for displaying the converted image signal on the display device; and displaying the image signal which is adaptively converted according to the characteristic of the display device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal with a related art camera built in;

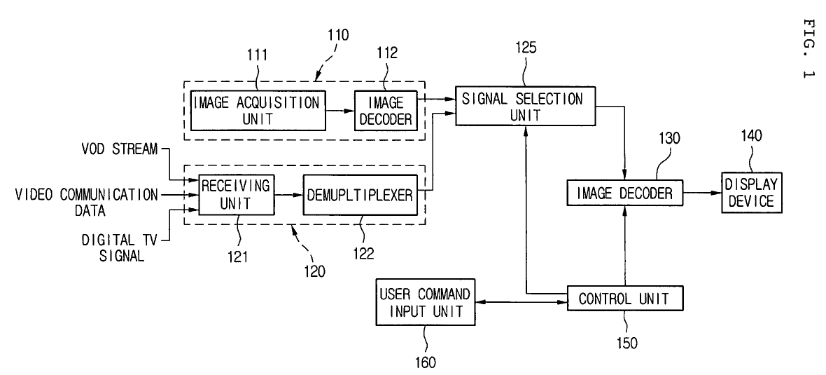

FIG. 2 is a block diagram of a mobile terminal having an image improvement unit according to the present invention; and

FIG. 3 is a flow chart illustrating a method for improving an image quality according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

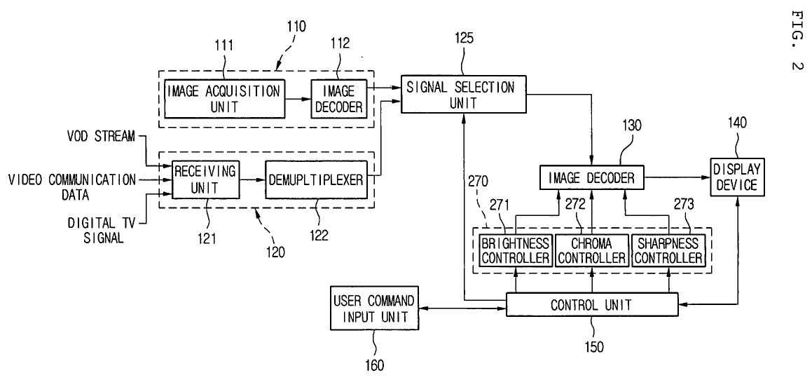

FIG. 2 is a block diagram illustrating a constitution of a mobile terminal according to the present invention. Referring to FIG. 2, the mobile terminal of the present invention includes an external image detection unit 110, an image signal detection unit 120, a signal selection unit 125, an image decoder 130, a display device 140, a control unit 150, a user command input unit 160, and an image quality improvement unit 270. Herein, the external image detection unit 110 acquires an image signal from an object. The image signal detection unit 120 acquires an image signal transmitted through a communication network. The signal selection unit 125 selects one of output image signals of the external image detection unit 110 or the image signal detection unit 120. The image decoder 130 decodes the image signal selected at the signal selection unit 125 for displaying it. The display unit 140 displays the image signal decoded at the image decoder 130. The control unit 150 controls the selecting of the signal and the decoding of the image, and further controls processing for improving an image quality. The user command input unit 160 operates the mobile terminal. The image quality improvement unit 270 improves the image quality of the image signal, which will be displayed on the display device 140 after it is decoded at the image decoder 130, through an adaptive compensation based on the characteristic of the display device.

The external image detection unit 110 is provided with an image acquisition unit 111 for converting an image of an object into an electrical signal, and an image encoder 112 for encoding the output signal of the image acquisition unit 111 and outputting the encoded signal. The image acquisition unit 111 may be a camera which is built in the mobile terminal. Although it is not illustrated in the drawings, the image acquisition unit 111 has a lens, a sensor and a camera controller in general. The image passing through the lens and the sensor is converted into a digital image signal at the camera controller, and the digital image signal is encoded at the image encoder 112.

The image signal detection unit 120 is provided with a receiving unit 121 for receiving a transmission stream having an image signal such as a video on demand (VOD) stream, a video communication data, a digital TV signal, or the like, and a demupltiplexer 122 for outputting an image data by demultiplexing the output of the receiving unit 121. The signal selection unit 125 selects one of several image data outputted from the image data receiving unit, and outputs the selected image data into the image decoder 130. The image decoder 130 decodes the encoded image data selected at the signal selection unit 125 and outputs the decoded image data into the display device 140. The display device 140 processes the decoded signal of the image decoder 130, and displays the image. The control unit 150 controls whole the functions and each of elements in the mobile terminal according to the user's command inputted through the user command input unit 160.

The image quality improvement unit 270 processes the image signal such that the image signal processed at the image decoder 130 is adaptive for the characteristic of the display device 140 according to a control signal applied from the control unit 150. Herein, the processing of the image signal, for example, is to appropriately compensate for the image signal, considering the characteristic of the display device 140. The compensation for the image signal at the image quality improvement unit 270 may be, for example, to control a color, a brightness, a chroma, a sharpness, or the like. To this end, the image quality improvement unit 270 is provided with a brightness controller 271, a chroma controller 272, and a sharpness controller 273.

The characteristic of the display device 140 according to the present invention, for example, is a color-reproducing characteristic according to a kind of the display device. There are various kinds of the display devices used for the mobile phone, and the various kinds of the display devices have the color-reproducing characteristics different from another one. Thus, in spite of the same image, which may be a moving image or a still image, it often occurs that the color sense of the original image is not represented on the display device intactly, according to the kind of the display device 140. That is, the color sense of the original image is differently reproduced according to the kind of the display device 140. In this case, although the color of the image is well reproduced at one mobile terminal, the color of the image may be often deteriorated at another mobile terminal in spite of the same image.

In the present invention, the color value is converted into a predetermined color value enough to reproduce the color of the original image according to the characteristic of the display device. To this end, a color matching table is provided for converting the color value according to the characteristic of the display device. The color matching table is used as being stored at a memory in the mobile terminal. Though the memory is not illustrated in FIG. 2, the control unit 150 may include this memory unit. A method for adaptively converting the color value of the image signal according to the characteristic of the display device can be achieved by compensating for the color value of the image data for every frame with respect to each pixel referring to the color matching table. By using the color matching table, it is possible to increase the conversion speed and efficiency of the color value. This is very useful in case of a real time moving picture.

Meanwhile, according to the present invention, the color sense is improved by converting the color value, and further, a factor such as brightness, chroma, sharpness, etc, which may have an effect on the image quality, is controlled, to thereby obtain much more improved image quality. The three factors of brightness, chroma, and sharpness may be all controlled. Alternatively, it is possible to selectively control one or two factor(s), which should be considered as being important, among the three factors. For instance, if the sharpness of the display image is sufficiently represented in comparison with the sharpness of the original image in one display device, whereas the sharpness of the display image is represented lower at the same level in comparison with the sharpness of the original image in another display device, the sharpness may be raised or lowered to a preset value. This will be identically applied to the control of chroma and brightness.

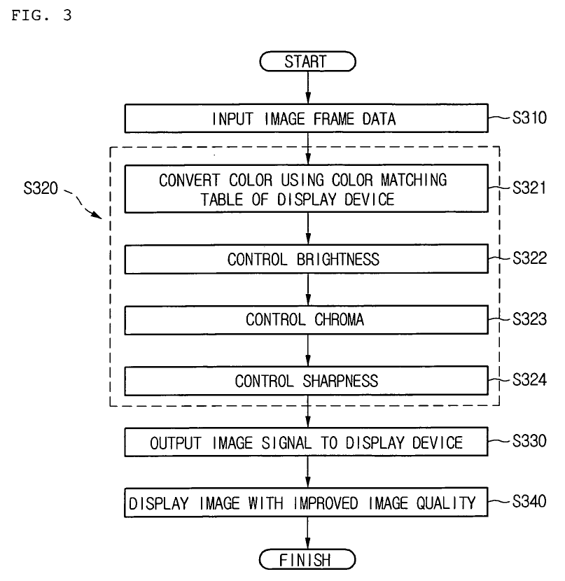

A method for improving an image quality of the mobile terminal according to the present invention will be illustrated herebelow with reference to FIG. 3.

An image frame data is inputted to the image decoder 130 (S310). Herein, the image data inputted to the image decoder 130 is one of the image data inputted through the external image detection unit 110 and the image signal detection unit 120, which is selected by the signal selection unit 125. The image data receiving unit of the mobile terminal receives various image data through the external image detection unit 110 or the image signal detection unit 120. The image data collected through various pathways is transferred to the image decoder 130 to be shown to the user, and is decoded at the image decoder 130. The signal selection unit 125 selects one of the image data according to the control of the control unit 150, and transfers it to the image decoder 130. Then, the image decoder 130 decodes the inputted image data.

The image data inputted to the image decoder 130 through the signal selection unit 125 undergoes the decoding procedure so that the image data is reproduced as an image in units of frame, which will be shown to the user.

The image quality improvement unit 270, before displaying the image in frame units decoded at the image decoder 130, performing an operation of converting the decoded image for every frame to be adaptive for the characteristic of the display device 140 (S320). The image signal converted to be adaptive for the characteristic of the display device 140 is outputted to the display device 140 (S330). Thereafter, the image with the improved image quality is displayed on the display device 140 (S340).

The operation of converting the image signal to be adaptive for the characteristic of the display device 140 by means of the image quality improvement unit 270 will be set forth in detail herebelow.

A first operation of the image quality improvement is to convert a color value (S321). By comparing the color to be displayed on the display device 140 with the color of the original image, a color matching is performed such that color to be displayed is similar or identical to the color of the original image. To this end, the color matching table of the display device 140 is used. Thus, by using color information of the color matching table of the display device 140, the color to be displayed on the display device 140 is compared with the color of the original image. According to the comparison result, the color value of each pixel is compensated to be similar or identical to the color of the original image.

Afterwards, operations of controlling whole the brightness, the chroma, and the sharpness for every image frame are performed with reference to general characteristics of the display device 140 (S322, S323 and S324). That is, the operation of controlling whole the brightness is performed using characteristic information of the display device 140 (S322), and the operation of controlling whole the chroma is performed using characteristic information of the display device 140 (S323). Then, the operation of controlling whole the sharpness is performed using characteristic information of the display device 140 (S324). Herein, the operations of controlling the brightness, the chroma, and the sharpness may be performed differently from the above.

The frame image which undergoes this image quality improvement process is outputted to the display device (S330), and the image with the improved image quality is displayed (S340).

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for adaptively improving an image quality according to a display device in a mobile terminal, the method comprising:
receiving a decoded image frame data for displaying it in the mobile terminal;
converting a color value of the inputted image frame data, considering the characteristic of the display device; and
displaying the converted image signal.

2. The method according to claim 1, wherein the image signal is an image of an object photographed by a camera of the mobile terminal.

3. The method according to claim 1, wherein the image signal is an image data stream received at the mobile terminal.

4. The method according to claim 1, wherein the converting of the color value is performed on every pixel of the image signal.

5. The method according to claim 1, wherein the color of an image to be displayed on the display device is matched with a color of an original image by the converting of the color value.

6. The method according to claim 1, further comprising controlling a brightness of an image signal to be displayed on the display device in accordance with the characteristic of the display device.

7. The method according to claim 1, further comprising controlling a chroma of an image signal to be displayed on the display device in accordance with the characteristic of the display device.

8. The method according to claim 1, further comprising controlling a sharpness of an image signal to be displayed on the display device in accordance with the characteristic of the display device.

9. A method for adaptively improving an image quality according to a display device in a mobile terminal, the method comprising:
setting a color matching table for an adaptive image compensation according to the characteristic of the display device in the mobile terminal;
converting a color value of a decoded image signal with reference to the color matching table, for displaying the converted image signal on the display device; and
displaying the image signal which is adaptively converted according to the characteristic of the display device.

10. The method according to claim 9, wherein the color matching table is set in accordance with the characteristic of the display device.

11. The method according to claim 9, wherein the converting of the color value is performed in units of frame.

12. The method according to claim 9, wherein the characteristic of the display device is a color-reproducing characteristic varied with a kind of the display device.

13. The method according to claim 9, wherein the converting of the color value is performed on every pixel of the image signal.

14. The method according to claim 9, wherein the color of an image to be displayed on the display device is matched with a color of an original image by the converting of the color value.

15. The method according to claim 9, further comprising controlling a brightness of an image signal to be displayed on the display device in accordance with the characteristic of the display device.

16. The method according to claim 9, further comprising controlling a chroma of an image signal to be displayed on the display device in accordance with the characteristic of the display device.

17. The method according to claim 9, further comprising controlling a sharpness of an image signal to be displayed on the display device in accordance with the characteristic of the display device.
